(19) United States
(12) Patent Application Publication
(10) Pub. No.: US 2026/0089677 A1
(43) Pub. Date: Mar. 26, 2026

(54) METHOD AND SYSTEM FOR TOA (TIME OF ARRIVAL) AND POSITIONING ESTIMATION IN OFDM/OFDMA BASED WAVEFORMS

(71) Applicant: RUNCOM Communication Ltd., Rishon Lezion (IL)

(72) Inventors: Ran HADAD, Petah Tikva (IL); Nadav HADAD, Beer Yaakov (IL); Zion HADAD, Rishon Lezion (IL)

(21) Appl. No.: 19/339,596

(22) Filed: Sep. 25, 2025

Related U.S. Application Data
(60) Provisional application No. 63/699,207, filed on Sep. 26, 2024.

(51) Int. Cl. H04W 64/00; H04B 17/309; H04L 25/02

(52) U.S. Cl. CPC H04W 64/00; H04B 17/346; H04L 25/0224

(57) ABSTRACT

Embodiments of the invention relate to robust Time of Arrival (ToA) estimation and Time Difference of Arrival (TDoA) positioning in OFDM/OFDMA systems under multipath and Non-Line-of-Sight (NLoS) conditions. The invention introduces a focused decimation framework that isolates the Line-of-Sight (LoS) region and suppresses distant multipath, producing short vectors suitable for real-time implementation. Multiple estimation methods are disclosed, including channel phase-based estimation, IFFT peak search, rising-edge detection, hybrid ESPRIT with Fast Iterative Adaptive Approach (FIAA), and Artificial Neural Network (ANN) models fused with ESPRIT outputs via a Multi-Layer Perceptron (MLP). For positioning, a reference-free TDoA formulation allows each radio unit (RU) to contribute independently, enabling robust outlier rejection of measurements from RUs without a clear LoS path to the user equipment (UE). In certain embodiments, an adaptive scheduler dynamically allocates radio resources for positioning based on quality-of-service requirements while coexisting with data communications

### FIELD

The present disclosure relates to Orthogonal Frequency Division Multiplexing (OFDM) and Orthogonal Frequency Division Multiple Access (OFDMA) based waveforms that may be used in communication systems, for estimating Time of Arrival (ToA) and positioning.

### BACKGROUND

Modern communication systems such as 5G require accurate ToA estimation for user equipment (UE) localization. When combined with Direction of Arrival (DoA) or Time Difference of Arrival (TDoA), ToA enables precise positioning.

In OFDM/OFDMA systems, ToA for each Radio Unit (RU) channel can be extracted using reference signals such as Demodulation Reference Signals (DMRS), Positioning Reference Signals (PRS), and Sounding Reference Signals (SRS). Alternatively, ToA may be derived from remodulated data compared to the received signal.

However, in non-line-of-sight (NLoS) environments, closely spaced multipath components degrade ToA accuracy significantly. Under these conditions, conventional methods often fail to provide reliable estimates, resulting in poor localization.

### SUMMARY

Embodiments of the invention disclose the combination of communication with localization, utilizing techniques such as TDoA. The disclosed methods improve the accuracy and robustness of ToA estimation in OFDM/OFDMA systems, particularly under multipath, NLoS, and interference conditions that degrade conventional approaches.

According to embodiments of the invention, ToA can be estimated reliably in LoS conditions across different bandwidths using a variety of techniques (methods 1-5 or their combinations). In multipath conditions, embodiments of the invention mitigate the degradation caused by closely spaced multipath components, where traditional average phase difference or limited-resolution IFFT estimators fail.

To address these limitations and ensure robust performance across a wide range of SNRs, delay spreads, and bandwidths, embodiments of the invention employ focused decimation with overlapping window integration to isolate the LoS region and suppress distant multipath. This preprocessing produces short, decimated vectors that enable accurate estimation and are suitable for real-time implementation. The LoS ToA is then estimated using one or more of the following techniques: pilot phase-based estimation which is also applicable in narrowband channels with two or more pilots, IFFT peak search, rising-edge analysis, combining the super-resolution methods Estimation of Signal Parameters via Rotational Invariance Techniques (ESPRIT) and Fast Iterative Adaptive Approach (FIAA), or ANN models (CNN- or transformer-based). In certain embodiments, an MLP combiner is further used to fuse ANN outputs with ESPRIT-derived delays, enhancing robustness and accuracy under challenging channel conditions.

For TDoA positioning, ToA measurements from multiple RUs, including redundant RUs, are combined to improve coverage and robustness under NLoS conditions. The TDoA equations are reformulated in a reference-free form, such that each RU contributes independently to the positioning solution without relying on a fixed reference RU. This avoids noise amplification and failure when a reference RU is under NLoS. Reliable LoS paths are adaptively selected and fused across RUs, and outlier rejection is applied using methods such as RANSAC or ANN classifiers. This reference-free formulation improves robustness, enabling accurate positioning even when some RUs are affected by multipath or NLoS conditions.

In some embodiments, an adaptive localization scheduler is further employed to allocate radio resources for positioning in real time. The scheduler dynamically adapts pilot density, bandwidth, and beam management based on QoS requirements, such as accuracy, latency, mobility, and propagation environment, while ensuring coexistence with data communications.

### BRIEF DESCRIPTION OF THE DRAWINGS

In the following detailed portion of the present description, the teachings of the present application will be explained in more detail with reference to the example embodiments shown in the drawings, in which:

FIG. 1 is a CIR of a single path using a rectangular vs. Chebyshev-60 window, and

FIG. 2 shows several multipath components with a Chebyshev-60 window, and

FIG. 3 illustrates the joint FIAA and ESPRIT LOS estimator scheme, and

FIG. 4 illustrates the hybrid ANN and ESPRIT LOS estimator scheme, and

FIG. 5 illustrates an embodiment of the CNN-based ToA model, and

FIG. 6 illustrates an embodiment of the hybrid combiner MLP model, and

FIG. 7 presents the 3GPP TDL-E channel model parameters for evaluation, and

FIG. 8 shows the ToA estimation methods' RMSE vs. SNR under varying TDL-E delay spreads, and

FIG. 9 shows the ToA estimation methods' RMSE vs. delay spread under varying TDL-E SNRs, and

FIG. 10 illustrates a positioning field test with a square-shaped trajectory, and

FIG. 11 illustrates a positioning field test with a circle-shaped trajectory, and

FIG. 12 illustrates a positioning field test with a flower-shaped trajectory.

### DETAILED DESCRIPTION

This section provides technical details and implementation methods for the LoS-ToA estimation techniques described in the invention. The methods are intended for use in OFDM/OFDMA communication systems like 5G and Wi-Fi and include both advanced classical signal processing and deep learning architectures, enabling enhanced accuracy and reliability in both LOS and NLoS conditions.

We perform focused decimation with overlapping, windowed integration to isolate the LoS region in time. This approach acts as a band-pass filter centered on the expected LoS delay, adaptively rejecting distant multipath components regardless of total delay spread. This avoids aliasing from distant paths and enables robust ToA estimation using short, decimated vectors, facilitating real-time implementation. This method is applied as a preprocessing step to enhance the ToA estimation methods.

Embodiments of the invention improve ToA estimation and TDoA positioning accuracy in OFDM/OFDMA systems by addressing the challenges in both Line-of-Sight (LoS) and Non-Line-of-Sight (NLoS) conditions:

### 1. LOS Conditions:

According to embodiments of the invention, ToA can be estimated accurately, regardless of bandwidth (methods 1, 2, 3, 4, 5 or combination of them).

### 2. NLoS Conditions:

According to embodiments of the invention higher bandwidth and increased Signal-to-Noise Ratio (SNR) can preserve accuracy.
Closely spaced multipath components degrade conventional ToA resolution, particularly when using average phase differences or limited-resolution Inverse FFT (IFFT) (ToA estimation methods 1, 2).
To address these limitations, embodiments of the invention disclose ToA estimation methods that all employ focused decimation to isolate the LoS region and suppress distant multipath components. Method 1 applies pilot phase-based estimation, Method 2 performs IFFT peak search, Method 3 refines estimation using rising-edge analysis, Method 4 combines ESPRIT with FIAA-based super-resolution, and Method 5 incorporates Artificial Neural Network (ANN) models with hybrid ANN-ESPRIT fusion using a Multi-Layer Perceptron (MLP) combiner. Together, these methods enable robust and accurate LoS delay estimation under both LoS and NLoS conditions.
With redundant RUs, RUs in pure NLoS conditions must be robustly filtered during position estimation, provided there are enough RUs with a LoS path. In such cases, a reference-free TDoA formulation is applied, in which each RU contributes independently to the positioning solution without reliance on a fixed reference RU, thereby avoiding noise amplification and ensuring robust estimation under NLoS conditions.

### 1. Radio Access Network (RAN) Considerations

Embodiments of the invention are applicable to wireless communication networks for example, where the RAN comprises one or more Radio Units (RUs) equipped with:
Simple single-antenna configurations
Multi-element antenna arrays for MIMO or massive MIMO (mMIMO) beamforming
Distributed antennas deployed across a coverage area to enhance spatial diversity

The disclosed methods may be applied in 3GPP-based (e.g., 5G NR) or ORAN-based architectures, as well as Wi-Fi networks. These architectures benefit from advanced ToA estimation techniques that suppress multipath interference and enhance delay estimation precision. This supports accurate user equipment (UE) localization when combined with DoA or TDoA from multiple RUs, even in challenging indoor and outdoor multipath environments.

### 2. Signal Model

We consider a frequency-selective wireless channel modeled as a Tapped Delay Line (TDL) with L paths

$$y ( t ) = {\sum }_{l = 0}^{L - 1} {α}_{l} x ( t - {τ}_{l} ) + z ( t )$$

where:
τ₀, α₀ corresponds to the LoS path delay and gain modeled as Rician-distributed
τ₁, . . . , τ_{L-1} and α₁, . . . , α_{L-1} are NLoS path delays and gains modeled as Rayleigh fading
z(t) is i.i.d. complex Gaussian noise

In the frequency domain (OFDM/OFDMA), after pilots (reference signal) de-rotation, or equalization by decoded and remodulated data, the estimated channel at index k is:

$$\hat{H} [ k ] = {\sum }_{l = 0}^{L - 1} {α}_{l} exp ( - j 2 π {f}_{k} {τ}_{l} ) + Z [ k ] , k = 0 , … , {N}_{P} - 1$$

where:
fₖ=s·Δf_{scs}·k are the N_{P} pilot frequencies, and s, Δf_{scs} are the pilot bin spacing and subcarrier spacing respectively
Z[k] complex Gaussian noise with variance

$${σ}_{z}^{2}$$

This model forms the basis for both classical and deep-learning-based estimation techniques described in the following section.

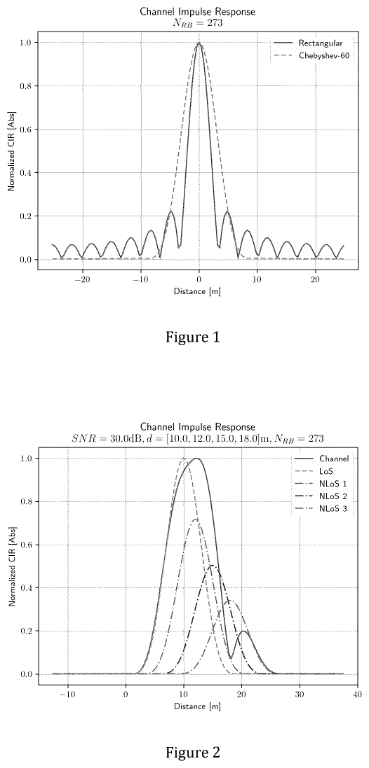

FIG. 1 illustrates the time-domain CIR in a single LoS path with a rectangular window versus a Chebyshev-60 window. FIG. 2 demonstrates the CIR with a Chebyshev-60 window in a multipath scenario with multiple closely spaced NLoS components with separation between the rising edge of LoS and NLos paths, while the LoS peak is distorted by NLoS interference.

### 3. Focused Decimation for Robust LoS Isolation and Multipath Rejection

This method performs a signal preprocessing stage to enable efficient and robust implementation of super-resolution delay estimators (e.g., FIAA, ESPRIT, ANN). It enhances ToA/TDoA-based localization performance by isolating the LoS region while attenuating far multipath components and noise.

The method aligns the frequency-domain channel to baseband (zero delay) using a coarse LoS delay estimate \hat{τ}_{STO} (symbol timing offset) obtained from coarse ToA estimation like methods 1, 2 in the sequel, or prior knowledge. Then, it applies windowed overlapping decimation to focus on the region around the LoS, while preserving essential features. This enables any of ToA estimation methods 1-5 to efficiently operate on a short, denoised vector and estimate the residual LOS delay \hat{τ}_{LoS} with higher accuracy. The final delay estimate is reconstructed as

$${\hat{τ}}_{LoS} = {\hat{\overline{τ}}}_{LoS} + {\hat{τ}}_{STO} .$$

Processing is performed according to the following steps:

### 1. Coarse Delay Estimation:

Estimate a coarse ToA estimation \hat{τ}_{STO} from method 2 on the full signal or take from prior knowledge of tracking loop.

### 2. Shifting the Signal to Baseband (DC):

Multiply the frequency-domain channel Ĥ[k] by a complex exponential to shift the LoS Area of Interest (AoI) to DC (around zero):

$$\tilde{H} [ k ] = \hat{H} [ k ] \cdot exp ( j 2 π {f}_{k} {\hat{τ}}_{STO} ) .$$

3. Windowed Decimation with Overlapping Blocks (Low-Pass Filtering):
Define parameters:
N_{D} desired number of decimated outputs
ρ∈[0,1) overlap ratio between blocks

$$D = ⌊ \frac{{N}_{P}}{{N}_{D} + \frac{ρ}{1 - ρ}} ⌋$$

decimation factor (stride size between consecutive overlapping windows)

$$W = ⌊ \frac{D}{1 - ρ} ⌋ \geq D$$

window length (number of pilot subcarriers per block)
w[m] window function (e.g., Chebyshev, Kaiser) of length W, with its peak at the center index
The decimated signal is computed as:

$$\overline{H} [ k ] = {\sum }_{m = 0}^{W - 1} w [ m ] \cdot \tilde{H} [ kD + m ] , k = 0 , … , {N}_{D} - 1 .$$

After decimation and alignment, the signal can be modeled as

$$\overline{H} [ k ] = {\sum }_{l = 0}^{L - 1} {\overline{α}}_{l} exp ( - j 2 π {\overline{f}}_{k} {\overline{τ}}_{l} ) + \overline{Z} [ k ] , k = 0 , … , {N}_{D} - 1$$

where:
\tilde{α}ₗ accounts for the gain attenuation and phase distortion from windowing and averaging:

$${\overline{α}}_{l} = {α}_{l} {\sum }_{m = 0}^{W - 1} w [ m ] exp ( - j 2 π {f}_{m} {\overline{τ}}_{l} )$$

where fₘ=s·Δf_{scs}·m.
f̅ₖ=s·D·Δf_{scs}·k are the N_{D} decimated pilot frequencies
τ̅ₗ=τₗ−\hat{τ}_{STO} are the downmixed delays
Z̅[k] complex Gaussian noise with reduced power due to the averaging window

### Practical Considerations:

This method remains robust under long delay spreads by using window functions with high sidelobe attenuation (e.g., 50 dB Chebyshev) and overlapping ratios of 0.5-0.6. These design choices effectively suppress distant multipath components and effectively eliminate aliasing, allowing to avoid full-bandwidth processing across all subcarriers.
The number of decimated outputs N_{D} is typically set to 15 samples to ensure a short (the decimation can be after averaging groups of pilots to improve SNR, fixed-length input for super-resolution algorithms or ANNs. This short and fixed dimensionality reduces model complexity while still capturing a flexible physical delay range due to the decimation stride and window configuration.
Rectangular windowing decimation without overlapping blocks should be avoided, as it leads to classical sinc-shaped attenuation in the delay domain resulting in inadequate suppression of distant multipaths that can alias into the LoS region and degrade accuracy.
The resulting decimated signal has enhanced SNR by a factor of approximately

$$S N {R}_{gain} = \frac{{( {\sum }_{m = 0}^{W - 1} w [ m ] )}^{2}}{{\sum }_{m = 0}^{W - 1} {w}^{2} [ m ]}$$

which in case of a rectangular window without overlap equals exactly W=D.

### 4. TOA Estimation Methods

The disclosed methods estimate LoS-ToA using either reference signals (e.g., DMRS, PRS, SRS) or decoded data that is remodulated and aligned with the received signal. Focused decimation is applied to isolate the LoS region and serves as a preprocessing step to enhance the robustness and real-time applicability, as well as mitigating interference from distant multipath components.

Methods 1, 2 are designed for dominant LoS conditions with well-separated multipath components, leveraging frequency-domain phase-based ToA estimation or direct CIR peak detection for fast and accurate delay extraction. Methods 3, 4, 5 are designed for multipath environments with closely spaced NLoS components. Method 3 detects the rising edge of the CIR for robust LoS-ToA estimation. Method 4 applies subspace-based ESPRIT fused with FIAA for enhanced multipath separation. Method 5 combines deep learning (ANN) with ESPRIT to fuse learned and model-based delay estimates. Each method addresses specific challenges such as limited bandwidth, low SNR or dense multipaths, to enable centimeter-level ToA precision and reliable performance.

In some embodiments, a RU equipped with multi-beamforming capability may be employed to attenuate or reject delayed multipath components arriving from distinct directions of arrival (DoAs). By spatially filtering such non-LoS components, the RU can enhance the detectability of the true LoS path, enabling accurate extraction of the shortest and most reliable LoS-ToA corresponding to the direct propagation path.

### 4.1. Method 1: Average Phase Difference Calculation

This method estimates the LoS-ToA by analyzing the phase trends across subcarriers in the frequency domain. The method is applicable across all bandwidths and is particularly effective in narrowband LoS channels with few subcarriers. It is most effective under medium-to-high SNR conditions and when the LoS component is dominant and not heavily masked by multipath. We perform an Average Phase Difference (APD) of subcarrier pairs with lag

[symbol]

$${\hat{τ}}_{LoS} = \frac{{\sum }_{n = 0}^{{N}_{P} - ℓ - 1} ∠ ( \hat{H} [ k ] \cdot \hat{H} * [ k + ℓ ] )}{( {N}_{P} - ℓ ) \cdot 2 π \cdot s \cdot ℓ \cdot Δ {f}_{scs}} .$$

This estimator locks onto the earliest dominant LoS delay and mitigates multipath interference by averaging the phase differences of pilot subcarrier pairs individually. This reduces sensitivity to incoherent additions and improves robustness in the presence of weak or moderately spaced multipaths. By taking the angle of each subcarrier pair before averaging, the estimator also projects the noise onto the unit circle, thereby limiting the variance introduced by additive noise. This makes it more resilient under low SNR conditions compared to performing the summation before taking the angle. Overall, the proposed method is robust to weak multipaths and low SNR, making it suited for realistic wireless environments.

### Practical Enhancements and Considerations:

Phase Difference/Correlation Lag [symbol] : Choosing an appropriate [symbol] is critical. Small [symbol] reduces ambiguity but may increase noise sensitivity; large [symbol] enhances resolution but risks wrapping and bias. Multiple lags from both estimators can be averaged or fused to mitigate these issues.
Subcarrier Selection: Focus on reliable, high-SNR subcarriers, possibly discarding edge bands or noisy bins.
Variance Filtering: Compute the variance of the phase differences to assess estimation stability. Discard estimates exceeding a pre-defined variance threshold.
Low-complexity HW implementation of complex correlation and phase extraction using methods such as CORDIC (Coordinate Rotation Digital Computer) or other equivalent techniques.
   4.2. Method 2: Initial Fast Estimation from Time Domain Spectrum

This method estimates the LoS-ToA by detecting the first significant peak in the oversampled time-domain power spectrum, derived from the full-band frequency-domain channel. It is effective under dominant LoS or widely spaced multipath scenarios, either as a standalone estimator or as an initialization for enhanced algorithms (methods 3, 4, 5).

### Processing is Performed According to the Following Steps:

1. Windowing:
   Apply a window function (e.g., rectangular, Hann) to the frequency-domain subcarriers to reduce spectral leakage before IFFT.
2. Zero-Padding for Oversampling:
   Zero-pad the frequency-domain signal (e.g., 4× or 8×) before the IFFT to increase time-domain resolution and enable sub-bin delay estimation.
3. IFFT Transformation:
   Perform the IFFT to obtain the CIR at a finer time resolution.
4. Time-Domain Spectrum and Noise Estimation:
   Compute the power spectrum as the squared amplitude of the CIR, and estimate the noise floor using a method such as median, truncated mean, etc.
5. Peak Detection and LoS Selection:
   Detect peaks in the spectrum using thresholds relative to the noise floor and maximum peak. The earliest significant detected peak is selected as the estimated LoS-ToA.
6. Quadratic Interpolation:
   Fit a quadratic curve around each significant peak to refine the delay estimate with sub-bin accuracy.
7. SNR and Delay Spread Estimation:
   Use the LoS peak amplitude and the estimated noise floor to compute the post-processing SNR. Also, compute the delay spread using the positions and amplitudes of all detected peaks.

To improve robustness in ToA/TDoA localization, the estimated LoS-ToA is output along with its SNR and delay spread, to be used as features in a confidence score for LoS/NLoS classification or for reliability weighting of ToA measurements from multiple RUs.

### 4.3. Method 3: Rising-Edge Based Estimation

This method refines LoS delay estimation by detecting the rising edge of the first multipath component in the time domain. It is designed to enhance robustness in dense multipath environments and enables precise ToA extraction by aligning, comparing, and calibrating against a single-path time-domain reference signal. The steps are as follows:
1. Coarse Delay Estimation:
   Estimate a coarse LoS \hat{τ}_{STO} (such as Method 2), followed by LoS-focused decimation to isolate the LoS region for high-resolution processing.
2. High-Resolution time-domain spectrum of LoS Region:
   Perform a highly oversampled inverse FFT (IFFT) on a windowed and zero-padded, decimated frequency-domain signal to obtain a smooth time-domain signal focused on the LoS region. Compute the power spectrum as the squared amplitude of the IFFT output and optionally perform smoothing (e.g., Savitzky-Golay filter). This step provides a dense temporal grid for accurate edge localization.
3. Generating a Time-Domain Reference Signal:
   Generate a reference signal offline that simulates an ideal single-path scenario. This reference undergoes identical processing steps as the received signal, including resource allocation, windowing, decimation, zero-padded IFFT, squared amplitude, and optional time-domain smoothing (e.g., Savitzky-Golay filter). These steps ensure structural and temporal alignment with the received signal, enabling accurate comparison, normalization, and calibration during derivative-based ToA estimation.
4. Extracting Time-Domain Signatures:
   Extract time-domain signatures from both the received and reference signals. The reference signal provides a clean, ideal single-path signature, while the received signal includes multipath and noise. These signatures are used for alignment and rising-edge analysis.
5. Rising-Edge Based Alignment and LoS-ToA Estimation:
   In one embodiment, rising-edge detection and delay estimation is performed after obtaining the signal and reference time-domain spectrums as follows:
   a. Noise Baseline Removal:
      A baseline noise estimate is obtained from the portion of the spectrum preceding the rising edge and is removed from the received signal spectrum for alignment with the reference.
   b. Rising-Edge Detection:
      The rising edge in the received signal spectrum is identified as the first point where the power exceeds a predefined threshold (TH) relative to the spectrum peak, indicating the offset of the earliest multipath arrival (presumed LoS).
   c. Gain-Invariant Alignment:
      The alignment between the received signal and the reference is performed using a gain-invariant search method. In one embodiment, a rising-edge segment of the received signal around TH is extracted and acts as a fixed rising-edge template. The reference is correlated with the template, i.e., scanned using sliding candidate windows representing possible alignment positions, and each window is correlated against the received rising-edge template. For each candidate window, a normalized correlation coefficient is computed by dividing the dot product of the window and the received rising-edge template by the product of their respective norms, thereby ensuring gain invariance. The alignment index is selected as the window that maximizes the normalized correlation coefficient, and the position may be further refined by interpolation. This process provides robust alignment of the reference and received signals independent of amplitude scaling.
   d. Delay Estimation and Refinement:
      After alignment, the LoS delay is estimated from the peak of the aligned reference relative to the received signal, or equivalently, by removing the alignment offset from the initial coarse LoS delay.

The rising-edge threshold TH is adaptable and may be trained or optimized based on SNR levels and spectrum features to improve robustness across varying channel conditions. The windowing function applied before the IFFT in step 2 determines the time-domain pulse shape. The IFFT window may be fixed according to the occupied bandwidth, or may be trainable, and in some embodiments is optimized using channel datasets or heuristic rules to reduce sidelobe leakage from NLoS components into the LoS rising edge and to enhance delay discrimination by producing a distinct rising-edge shape. Additional optimizations may include adaptive selection of window type, length, or weighting coefficients based on deployment scenario, bandwidth, delay spread, or target accuracy.

### 4.4. Method 4: Joint FIAA and ESPRIT Estimation

This method fuses the subspace-based ESPRIT algorithm with the FIAA to provide reliable and high-resolution delay estimation in dense multipath scenarios. While ESPRIT delivers accurate delay estimates under conditions with few dominant taps and high SNR, FIAA offers robustness by directly estimating the delay spectrum without requiring prior model-order knowledge. The combination enables complementary advantages-ESPRIT for high-resolution delay estimation based on model-order subspace decomposition, and FIAA for robust spectrum generation with amplitude information suitable for detection and thresholding.

For reference, the ESPRIT algorithm is a known subspace-based technique for delay estimation, operating by forming a covariance matrix, applying eigenvalue decomposition, and solving a rotational invariance relation to obtain candidate delays. Similarly, the Fast Iterative Adaptive Approach (FIAA) is a known iterative spectral estimation technique that refines spectral power estimates using fast Toeplitz solvers. These conventional algorithms are described here to provide context. Embodiments of the present invention apply modifications and hybridization of ESPRIT and FIAA to achieve improved reliability under dense multipath, which forms part of the inventive contribution.

### 4.4.1. ESPRIT Algorithm

Subspace-based super-resolution techniques (MUSIC, ESPRIT, etc.) provide accurate delay estimation by separating signal and noise subspaces through eigenvalue decomposition (EVD) of the sample covariance matrix. ESPRIT is computationally efficient compared to spectral methods like MUSIC, as it directly estimates the delays from the signal subspace without performing spectral search over candidate delays.

Since only a single snapshot is available, we perform spatial smoothing processing (SSP) to obtain a full-rank covariance matrix and improve signal separation. This is achieved by dividing the decimated channel H̅ into overlapping subvectors of length M

$${\overline{H}}_{i} = [ \begin{matrix}\overline{{H}_{i}} \\ {\overline{H}}_{i + 1} \\ ⋮ \\ {\overline{H}}_{i + M - 1}\end{matrix} ] ∈ {ℂ}^{M \times 1} , i = 0 , … , {N}_{D} - M ,$$

and calculating the SSP covariance by

$${\hat{R}}_{\overline{H}} = \frac{1}{{N}_{D} - M + 1} {\sum }_{i = 0}^{{N}_{D} - M} {\overline{H}}_{i} {\overline{H}}_{i}^{H} .$$

To further improve the signal separation, we perform forward-backward averaging (FB) by

$$\hat{R} \frac{F B}{H} = \frac{1}{2} ( {\hat{R}}_{\overline{H}} + J {\hat{R}}_{\overline{H}}^{*} J ) ,$$

where J is the exchange matrix with ones on its antidiagonal and zeros elsewhere equivalent to a flip operator. To obtain a real-valued covariance matrix suitable for more efficient EVD we perform unitary FB

$${\hat{R}}_{\overline{H}}^{U - FB} = {Q}^{H} \hat{R} \frac{F B}{H} Q ,$$

where Q is any unitary, column conjugate symmetric. For Q chosen as

$$Q = \frac{1}{\sqrt{2}} [ \begin{matrix}I & jI \\ J & - jJ\end{matrix} ] , Q = \frac{1}{\sqrt{2}} [ \begin{matrix}I & 0 & jI \\ {0}^{T} & \sqrt{2} & {0}^{T} \\ J & 0 & - jJ\end{matrix} ] ,$$

for even and odd sized covariances respectively, we directly calculate the unitary FB covariance

$${\hat{R}}_{\overline{H}}^{U - FB} = Re \{ {Q}^{H} {\hat{R}}_{\overline{H}} Q \} ,$$

which requires only additions of \hat{R}_{H} submatrices and flipped submatrices. After EVD, the eigenvectors of the unitary FB need to be de-rotated to continue with the ESPRIT calculations

$${U}^{FB} = Q {U}^{U - FB} .$$

To determine the number of signal components N_{S}, we use the Akaike Information Criterion (AIC) with FB correction applied to the eigenvalues of

$${\hat{R}}_{\overline{H}}^{U - FB} .$$

The AIC minimizes:

$$A I C [ m ] = - ( M - m ) {N}_{S S P} \cdot log ( \frac{{( {\prod }_{i = m + I}^{M} {λ}_{i} )}^{\frac{1}{M - m}}}{\frac{1}{M - m} {\sum }_{i = m + 1}^{M} {λ}_{i}} ) + m ( 2 M - m + 1 ) / 2$$

for each candidate order m, and selects the N_{S} with the minimum AIC score, where λ are the eigenvalues of

$${\hat{R}}_{\overline{H}}^{FB} ,$$

and N_{SSP} is the effective SSP number of snapshots typically taken as

$$⌊ \frac{{N}_{D}}{M} ⌋ .$$

Once N_{S} is selected, we extract the signal subspace U_{S} as the N_{S} eigenvectors of U^{FB} corresponding to the largest eigenvalues, and partition it into two sub-matrices: U₁, which contains the first M−1 rows of U_{S}, and U₂ which contains the last M−1 rows of U_{S}. The ESPRIT rotational matrix is given by

$$Ψ = {U}_{1}^{†} {U}_{2} ,$$

where

$${U}_{1}^{†}$$

is the pseudo-inverse. EVD is performed on Ψ to obtain its complex eigenvalues ψₘ, m=0, . . . , N_{S}−1. The delays are then extracted from the eigenvalues by

$${{τ}^{\hat{\_}}}_{m} = \frac{∠ ( {ψ}_{m} )}{2 π \cdot s \cdot D \cdot Δ {f}_{s c s}} .$$

### 4.4.2. FIAA Algorithm

Fast Iterative Adaptive Approach (FIAA) is used for robust, high-resolution spectral estimation. The IAA spectral estimate is formed by iteratively estimating α̅(τ̅ₘ) from the reduced channel H̅ of length N_{D}, and a structured covariance R_{N}_{_{D}}∈ [symbol] ^{N}^{_{D}}^{×N}^{_{D}}, until practical convergence

$$\overline{α} ( {\overline{τ}}_{m} ) = \frac{{f}_{{N}_{D}}^{H} ( {\overline{τ}}_{m} ) {R}_{{N}_{D}}^{- 1} \overline{H}}{{f}_{{N}_{D}}^{H} ( {\overline{τ}}_{m} ) {R}_{{N}_{D}}^{- 1} {f}_{{N}_{D}} ( {\overline{τ}}_{m} )}$$

$${R}_{{N}_{D}} = {\sum }_{m = 0}^{{N}_{F I A A} - 1} {\vert \overline{α} ( {\overline{τ}}_{m} ) \vert}^{2} {f}_{{N}_{D}} ( {\overline{τ}}_{m} ) {f}_{{N}_{D}}^{H} ( {\overline{τ}}_{m} )$$

where f_{N}_{_{D}}(τ̅ₖ)=[1e^{2πf̅}^{₁}^{τ̅}^{ₘ} . . . e^{2πf̅N}^{_{D}}^{-1τ̅}^{ₘ}], and

$${\overline{τ}}_{m} = \frac{m}{s \cdot D \cdot Δ {f}_{S C S} {N}_{FIAA}} for - \frac{{N}_{F I A A}}{2} \leq m \leq \frac{{N}_{F I A A}}{2} - 1 ,$$

with R_{N}_{_{D}} initialized to the identity matrix I_{N}_{_{D}}, and N_{FIAA} taken as a power of 2 for efficient radix-2 FFT. The FIAA spectrum of the LoS AoI is given by S(τ̅ₘ) [symbol] |α̅(τ̅ₘ)|².

We calculate an efficient FFT-accelerated Fast IAA (FIAA) implementation, exploiting the Toeplitz structure of the covariance matrix to enable efficient computation. Specifically, the algorithm leverages:
Gohberg-Semencul (GS) factorization for calculating the inverse of the Hermitian Toeplitz covariance matrix via convolution operations.
Levinson-Durbin recursion for solving the Toeplitz system in linear time.

The FIAA algorithm can be described in terms of the following steps:

Given a complex-valued input vector x∈ [symbol] ^{N}, we estimate the spectral power S(ωₖ) [symbol] |α(ωₖ)|² over k=0, . . . , M−1 frequency bins as follows:
1. Initialize power spectrum: S⁽⁰⁾(ω)=|IFFT_{M}(x)|², for M>>N (e.g., M=512, N=16), and a loading factor δ.
Iterative Update (i=1, . . . , iₘₐₓ):
2. Estimate autocovariance

$${r}_{N}^{( i )}$$

from spectrum:

$${r}_{N}^{( i )} [ n ] = F F {T}_{M} ( {S}^{( i - 1 )} ) [ n ] , n = 0 , … , N - 1$$

$${r}_{N}^{( i )} [ 0 ] = ( 1 + δ ) {r}_{N}^{( i )} [ 0 ]$$

3. Solve the Yule-Walker system using Levinson-Durbin algorithm to obtain a_{N-1}:

$${R}_{N} = Toeplitz ( {r}_{N}^{( i )} )$$

$$⇒ {R}_{N - 1} {a}_{N - 1} = - {r}_{N - 1}$$

where

$${r}_{N - 1} [ n ] = {r}_{N}^{( i )} [ n + 1 ] , n = 0 , … , N - 2 ,$$

and R_{N-1} is the lower-right N−1×N−1 submatrix of R_{N}, obtained by removing its first row and first column.
4. Form the Gohberg-Semencul (GS) inverse matrix:

$${R}_{N}^{- 1} = L ( t ) {L ( t )}^{H} - L ( z ) {L ( z )}^{H}$$

where L(⋅) is a lower triangular Toeplitz matrix,

$$t = {[ \begin{matrix}1 & {a}_{N - 1}^{T}\end{matrix} ]}^{T} ,$$

and z=[0(Ja_{N-1})^{H}]^{T}, i.e,

$$z [ 0 ] = 0 , z [ n ] = t * [ N - n ] for n = 1 , … , N - 1 .$$

For calculating the numerator part

$${d}_{N} = {R}_{N}^{- 1} x ,$$

all 4 matrix-vector multiplications involving L(⋅) are implemented using FFT-based convolutions with FFT size N_{conv}≥2N−1(2^{┌ log}^{₂}^{(2N-1)┐} for efficient radix-2 FFT).
5. Compute Spectrum Numerator (FFT-Based GS Solution):

$$v ( {ω}_{k} ) {=}^{Δ} {f}_{N}^{H} ( {ω}_{k} ) {R}_{N}^{- 1} x = {IFFT}_{M} ( {d}_{N} ) [ k ]$$

6. Compute GS trigonometric polynomial coefficients φ_{d}

$${R}_{N}^{- 1}$$

defined as:

$${φ}_{d} = {\sum }_{i - j = d} {[ {R}_{N}^{- 1} ]}_{i , j} , d = - N + 1 , … , N - 1 .$$

That is, each φ_{d} corresponds to the sum of the elements along the d-th diagonal of

$$- {R}_{N}^{- 1} .$$

7. Compute the denominator for all frequencies (via FFT of φ_{d}):

$$ϕ ( {ω}_{k} ) = {\sum }_{d = - N + 1}^{N - 1} {φ}_{d} \cdot {e}^{- j 2 π kd / M} .$$

The Hermitian-symmetric sequence φ_{d} is padded to length M, then transformed using a single FFT operation to evaluate φ(ωₖ) efficiently across all frequency bins.
8. Update spectrum amplitudes and power:

$${α}^{( i )} ( {ω}_{k} ) = \frac{v ( {ω}_{k} )}{ϕ ( {ω}_{k} )} , {S}^{( i )} ( {ω}_{k} ) = {\vert {α}^{( i )} ( {ω}_{k} ) \vert}^{2}$$

9. Check for convergence:

$$\frac{‖ {S}^{( i )} ( ω ) - {S}^{( i - 1 )} ( ω ) ‖}{‖ {S}^{( i - 1 )} ( ω ) ‖} < ε$$

If converged, terminate. Otherwise, continue to next iteration.

### 4.4.3. Motivation for Combining ESPRIT and FIAA

Standalone subspace methods such as ESPRIT can suffer from reduced reliability under moderate SNR conditions or dense multipath environments. Although ESPRIT provides accurate estimates when the number of signal paths is low and well-separated, its performance degrades due to the following issues:
Inaccurate estimation of the true model order using standard criteria (e.g., AIC)
Presence of many closely spaced multipath components or low SNR
Ambiguity determining the LoS delay among multiple estimated roots
Poor amplitude recovery due to least-squares (LS) projection post-processing

In contrast, FIAA offers several advantages:
Operates without requiring a prior signal model order estimate
Provides robust spectral estimation, including accurate amplitude recovery from spectral peaks
Maintains performance under low SNR and short observation durations
Supports signal order determination and validation of delays estimated by ESPRIT, particularly in cases where AIC-based model order selection fails

However, FIAA lacks the model-based refinement of ESPRIT and generally exhibits lower accuracy in sparse or high-SNR scenarios. Despite this, FIAA excels in the reliable detection and ordering of multipath components, and in improving LoS selection robustness.

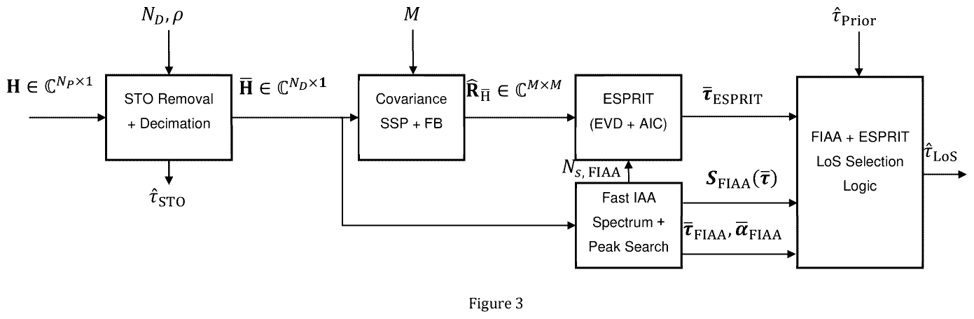

The proposed method shown in FIG. 3 has the following notation and operates as follows:
N_{P} is the number of pilots
\hat{τ}_{STO} is the coarse LoS TOA estimation used to shift the CIR to DC
N_{D} is the decimated number of pilots with windowed block overlap ρ
\hat{R}_{H̅} is the SSP+FB covariance matrix of size M×M
τ̅_{ESPRIT} are the ESPRIT residual ToA estimations of length Nₛ<M with AIC model order
S_{FIAA}(τ̅) is the FIAA spectrum
τ̅_{FIAA}, α̅_{FIAA} are the FIAA N_{s, FIAA} detected residual ToA and gain estimations
\hat{τ}_{Prior} is the prior estimation based on rising-edge detection and feedback from prior frames, motion models, or statistical priors
\overline{\hat{τ}}_{Sel} is the selected residual LoS-ToA estimation
\hat{τ}_{LoS}=\overline{\hat{τ}}_{Sel}+\hat{τ}_{STO} is the final LoS-ToA estimation
1. Preprocessing with Focused Decimation:
   Isolate the LoS region by applying windowed decimation (e.g., Chebyshev-50 dB window with 0.5-0.6 overlap), to output a reduced-length vector of size N_{D}˜15-20 samples, enabling efficient ESPRIT and FIAA computations.
2. ESPRIT-Based Candidate Extraction:
   Estimate candidate delays using ESPRIT by applying subspace decomposition on a sample covariance matrix. A full-rank covariance matrix of size M is computed from the decimated vector using spatial smoothing (SSP) with unitary forward-backward (FB) averaging, enabling reliable Eigenvalue Decomposition (EVD) from a single snapshot.
   Use AIC to determine the signal model order N_{S}, and extract signal subspace.
   Extract N_{S} candidate delay estimates from the ESPRIT roots.
3. FIAA Spectrum Estimation, Peak Search, and Delay Estimation:
   Apply FIAA on the same decimated channel vector to compute a high-resolution delay spectrum with amplitude estimates.
   Estimate the FIAA spectrum noise floor (e.g., median) and detect N_{S,FIAA} peaks with SNR above a predefined threshold.
   Refine the estimated delays using peak interpolation (e.g., quadratic fitting).
4. Candidate Confidence Calculation:
   Compute a joint confidence score for each ESPRIT delay based on the following:
      Support from prior information or prediction models (e.g., previous frames, motion models, statistical priors).
      Extracted FIAA features:
         Peak locations, amplitudes, widths, and prominences
         First rising-edge location
         Power level of the surrounding spectrum region, to confirm that each ESPRIT candidate aligns with a prominent spectral feature
5. Hybrid LoS Selection:
   Check ESPRIT reliability by confirming candidates have minimal spectral support near their expected delay locations and validate AIC model order with N_{S,FIAA}≤N_{S}.
   If ESPRIT is reliable, Select the ESPRIT candidate with the highest confidence score.
   Otherwise, fall back to selecting the LoS delay directly from the first significant peak in the FIAA spectrum.
6. Optional Multi-Candidate Output
   For downstream modules such as multi-hypothesis tracking (MHT), TDoA consistency filtering across sensors, or motion-model based trajectory prediction frameworks (e.g. Kalman filtering), optionally output multiple ESPRIT+FIAA LOS delay candidates with associated confidence scores for deferred decision-making.

### 4.4.4. Remarks and Optimizations

### Efficient Covariance Estimation for ESPRIT:

To enable efficient ESPRIT processing, a compact full-rank covariance matrix of typical size M=8 is constructed by applying spatial smoothing (SSP) to the decimated vector of length N_{D}=2M−1=15. SSP estimates the covariance matrix using overlapping sub-vectors extracted from the decimated channel and we leverage Hermitian symmetry to reduce redundant calculations. This structure enables efficient reuse of computations, lowering the number of complex multiplications to

$$\frac{M ( M + 1 )}{2} + M ( {N}_{D} - M )$$

instead of M²(N_{D}−M). The choice of M=8 ensures efficient EVD-based subspace estimation while preserving sufficient subspace dimensionality N_{S}<M within the LoS-focused delay region.

### FFT-Based GS Polynomial Evaluation in FIAA:

The FIAA denominator is computed via an entirely FFT-based procedure that avoids explicit matrix inversion or forming and multiplying triangular matrices in the G factorization of

$${R}_{N}^{- 1}$$

and summing of matrix diagonals. Specifically, we evaluate the quadratic form

$${f}_{{N}_{D}}^{H} ( {\overline{τ}}_{m} ) {R}_{{N}_{D}}^{- 1} {f}_{{N}_{D}} ( {\overline{τ}}_{m} )$$

through spectral FFT-based convolution of GS trigonometric polynomial coefficients.

For Step 6 of the FIAA algorithm, the diagonal coefficients Pa are computed by:
1. Compute FFTs of size N_{conv}≥2N_{D}−1 for the GS vectors t, z, \tilde{t}, \tilde{z} denoted as T, Z, \tilde{T}, \tilde{Z}, where \tilde{t}[n]=n·t[n], \tilde{z}[n]=n·z[n].
2. Power and cross terms of L(t)L(t)^{H} and L(z)L(z)^{H} are replaced using vectorized spectral-domain operations, and an IFFT is then applied to produce all φ_{d} coefficients across diagonals simultaneously. The final formula is

$${φ}_{d} = ( N - d ) \cdot V [ - d mod {N}_{c o n v} ] - \tilde{V} [ - d mod {N}_{c o n v} ] ,$$

for d=0, . . . , N−1, and φ_{d}=φ*_{-d} for d=−N+1, . . . , −1, where

$$V = {IFT}_{{N}_{c o n v}} ( T ⊙ {T}^{*} - Z ⊙ {Z}^{*} )$$

$$\tilde{V} = {IFT}_{{N}_{c o n v}} ( \tilde{T} ⊙ {T}^{*} - \tilde{Z} ⊙ {Z}^{*} )$$

and ⊙ denotes point-wise multiplication.

### Implementation Efficiency and Real-Time Feasibility:

The ESPRIT+FIAA framework is designed for real-time or low-complexity implementation by leveraging focused decimation to isolate the LoS region (N_{D}˜10-20 samples). All FIAA computations rely on FFT/IFFT and element-wise vector operations, with Levinson-Durbin recursion being the only non-FFT iterative procedure. The main computational load consists of three FFT/IFFT operations of size N_{FIAA}, along with multiple small FFTs/IFFTs of size N_{conv} for efficient convolutions. A typical configuration uses N_{D}=15 and N_{FIAA}=512, providing a high-resolution delay grid over the focused LoS region with minimal computational overhead.

### 4.5. Method 5: Deep Learning Based Hybrid LoS Delay Estimation

This method introduces a hybrid deep-learning framework for LoS delay estimation, replacing the FFT-based FIAA spectral estimation with a neural network (ANN) based on Convolutional or Transformer architectures, and the ESPRIT+FIAA decision logic with a learned Multi-Layer Perceptron (MLP) combiner. This approach is designed for low-latency, hardware-friendly, and low-complexity applications, especially in challenging multipath or fading environments.

While the ANN model can independently estimate the delay directly and outperform classical methods in challenging channels, fusing it with ESPRIT-based processing helps overcome the accuracy floor of standalone ANN models (typically ˜3 cm RMSE), achieving sub-cm accuracy also in LoS-dominated, high-SNR regimes.

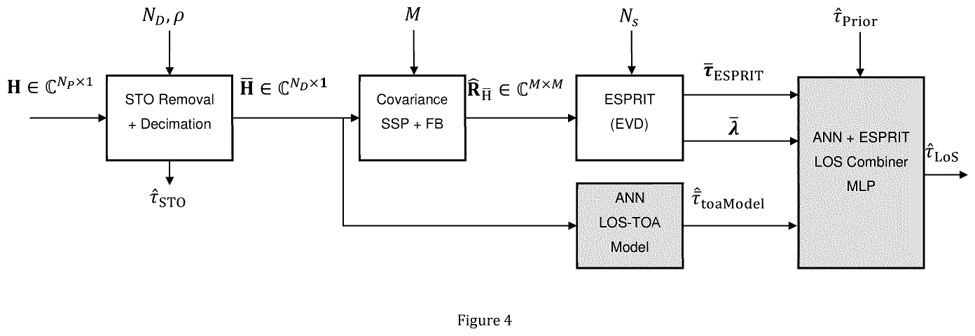

The proposed method shown in FIG. 4 has the following notation and operates as follows:
N_{P} is the number of pilots
\hat{τ}_{STO} is the coarse LoS TOA estimation used to shift the CIR to DC
N_{D} is the decimated number of pilots with windowed block overlap ρ
\hat{R}_{H̅} is the SSP+FB covariance matrix of size M×M
Nₛ<M is the number of ESPRIT signal multipaths to estimate
τ̅_{ESPRIT} are the ESPRIT residual ToA estimations of fixed length Nₛ<M
λ̅ are the covariance eigenvalues of length M
\overline{\hat{τ}}_{toaModel} is the ANN model residual LoS-ToA estimation
\hat{τ}_{Prior} is the prior estimation based on rising-edge detection and feedback from prior frames, motion models, or statistical priors
\overline{\hat{τ}}_{Hybrid} is the final combined residual LoS-ToA estimation
\hat{τ}_{Los}=\overline{\hat{τ}}_{Hybrid}+\hat{τ}_{STO} the final LoS-ToA estimation
1. Preprocessing with Focused Decimation:
   Isolate the LoS region by applying windowed decimation (e.g., Chebyshev-50 dB window with 0.5-0.6 overlap), to output a reduced-length vector of size N_{D}˜15-20 samples, enabling efficient ANN and ESPRIT computations.
2. Standalone ANN-Based Delay Estimation:
   A trained ANN processes the decimated vector to predict a scalar LoS-ToA estimate directly.
   Input features/channels may include the real/imag parts or amplitude/phase vectors of the decimated FD pilots.
   The ANN outputs a complex vector of the same size as the input and has a ToA head for calculating the ToA scalar output, derived by:
      Direct autocorrelation and phase-based delay extraction
      Soft classification across delay bins
      Regression with confidence scoring
3. Hybrid Fusion of Pretrained ANN with ESPRIT via MLP (Optional Enhancement):
   An MLP combines the ANN prediction with ESPRIT outputs:
      Estimate ESPRIT delay candidates with fixed N_{S} (typically, N_{S}=M−2) as in Method 4 (SSP+U-FB).
      Inputs to the MLP include: ESPRIT delay estimates, normalized covariance eigenvalues, and ANN delay estimate.
      The MLP learns to assign dynamic weights for combining the ANN-estimated delay and the ESPRIT delay closest to the ANN prediction, to minimize the hybrid LoS estimation error.

### Practical Considerations:

The ANN and MLP operate on reduced-length input vectors, fixed to the same N_{S} in all scenarios, making them suitable for low-complexity hardware deployment.
The standalone ANN is trained on synthetic or real multipath channel datasets with varying SNRs and delay spreads, achieving <10 cm RMSE across realistic wireless channels by learning to isolate the LoS component and suppress NLoS paths, acting as a nonlinear filter that preserves the input dimensionality.
Transformer-based variants replace convolution with self-attention, improving performance under long-range multipath conditions.
The MLP design allows inclusion of prior-frame delay estimates, enabling use in TDoA filtering and MHT pipelines.

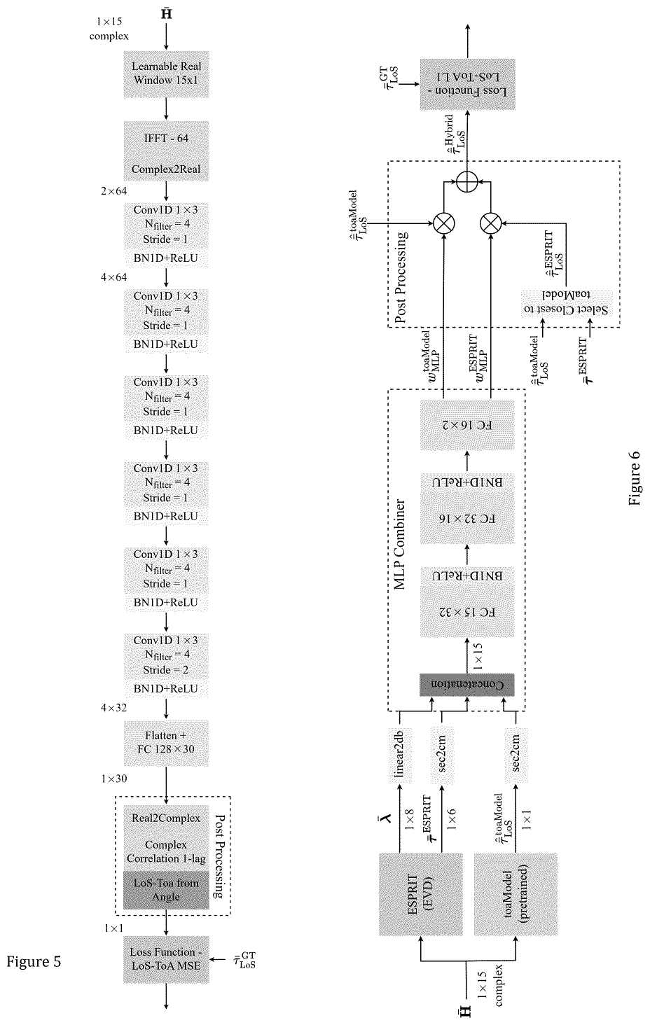

Examples of a CNN-based ANN model and a hybrid combiner MLP model are shown in FIG. 5 and FIG. 6, respectively, for N_{D}=15, M=8, and N_{S}=6.

The CNN-based delay estimation proceeds through the following steps:
1. Windowing and Frequency-to-Time Conversion:
   A learnable real window function is applied to the complex-valued decimated FD pilot vector. A zero-padded IFFT is then performed to enhance time-domain resolution and optimize the pulse shape.
2. Convolutional Feature Extraction:
   The real and imaginary parts of the time-domain vector are separated to two input channels and are passed through a stack of convolutional layers with batch normalization and ReLU activation. Each stage contains multiple learnable filters that extract localized multipath features across time.
3. Flattening and Frequency Reconstruction:
   The final feature maps are flattened and passed through a fully connected layer, which reconstructs a complex-valued vector back in the frequency domain, maintaining a consistent dimensionality with the input.
4. ToA Estimation via Phase Extraction:
   A complex autocorrelation is applied to the network's output. The phase angle of the resulting vector is extracted and scaled to compute the final LoS delay.

### 4.6. ToA Estimation Performance

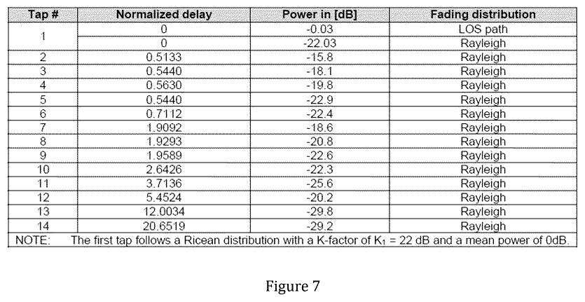

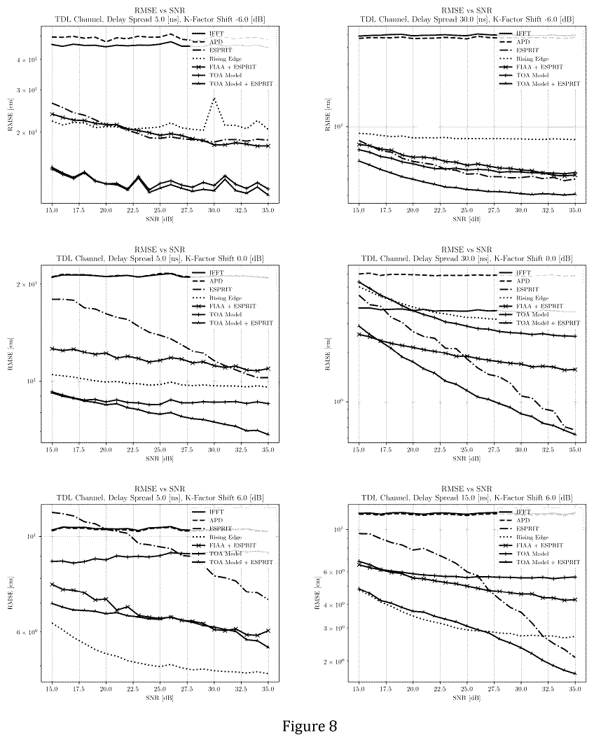

The channel parameters are simulated based on the 3GPP TDL-E channel model shown in FIG. 7, with 14 propagation paths, suitable for LoS evaluations. The LoS path follows a Rician fading distribution, while the remaining 13 NLoS paths follow a Rayleigh fading distribution. The normalized delays are scaled to the desired delay spread and shifted relative to the target LoS delay. The nominal channel model K-factor is adjusted to weaken or strengthen the LoS path power relative to the NLoS paths, which requires re-normalization of the delays to maintain unit RMS delay spread.

The tests are performed under short delay-spread conditions, using a system configuration with a full bandwidth of 100 MHz (273 resource blocks) and 30 kHz subcarrier spacing with a pilot spacing of 6, corresponding to 2 pilots per resource block. This setup represents best-case performance in challenging close-multipath scenarios. The decimated vector length and the ESPRIT covariance matrix size are set to N_{D}=15 and M=8, respectively. The decimation block stride is set to 33 with approximately 0.6 block overlap, using a Chebyshev window of length 82 and 50 dB attenuation.

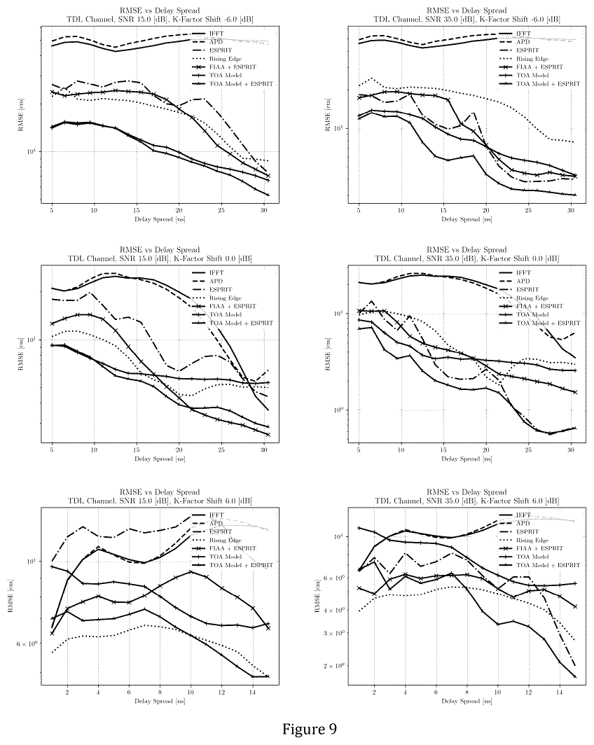

FIG. 8 and FIG. 9 present the RMSE performance of the ToA methods, including both the CNN-based ToA model and the hybrid CNN+ESPRIT model, across varying SNR levels and short delay spreads. For reference, ESPRIT is tested with N_{S}=6, and the LoS delay is taken as the closest delay to the ground-truth LoS for ideal LoS selection. The IFFT-based method is implemented with a rectangular window to achieve maximum resolution, while the APD method uses a pilot-pair lag of [symbol] =4. The rising-edge estimator uses a 512-point IFFT (oversampling factor of approximately 34) with a generalized Hamming window with a parameter of 0.6, followed by time-domain spectrum smoothing using a Savitzky-Golay filter of length 64 and polynomial order 2, and the rising-edge threshold is fixed at 5×10⁻³ relative to the spectrum peak. FIAA is implemented with a 512-point IFFT to generate a high-resolution spectrum. All algorithm parameters remain fixed during testing, even though they may be configured dynamically in practice.

The higher accuracy of the rising-edge, joint FIAA and ESPRIT, and hybrid CNN approaches is demonstrated in challenging scenarios across short delay spreads when compared to IFFT and APD. The hybrid CNN model, when compared to the standalone CNN model achieves improved accuracy at high SNR and larger delay spreads, reducing RMSE to approximately 1 cm.

5. Robust Positioning with TDoA Estimation

This invention relates to a robust method for TDoA position estimation based on ToA measurements (from Methods 1-5) collected from one or more distributed RUs. The distributed RUs are clock-synchronized in advance through calibration, for example using LoS transmitters with known locations or equivalent synchronization techniques. This synchronization ensures that ToA measurements across RUs are aligned to a common time reference, thereby enabling accurate TDoA computation. The method supports TDoA and can optionally combine Direction of Arrival (DoA) for enhanced accuracy.

In TDoA-based positioning within d-dimensional coordinates, the minimum number of RUs required for unambiguous positioning is N_{RU}≥d+1. To improve coverage and robustness under NLoS conditions, additional redundant RUs are necessary. With redundancy, the system adaptively selects and fuses the most reliable LoS paths across multiple RUs and beams, applying RU-weighted optimization and search procedures in combination with RANSAC or ANN-based outlier and NLoS rejection.

Gauss-Newton (GN) optimization is used to initialize the UE position, with initialization optionally performed from multiple starting points based on adaptively weighted RU measurements and outlier rejection techniques (e.g., RANSAC, ANN). For tracking, Extended or Unscented Kalman Filtering (EKF/UKF) is applied, incorporating dynamic updates of measurement and motion variances according to SNR, BW, delay spread, and variable time step.

### 5.1. Position Estimation Using Multiple Reliable LoS Paths

The location is calculated using multiple reliable LoS paths with one or several RUs:
1. For One RU with One or More Beams
   1. Selecting the Most Reliable Path:
      The system selects the shortest and most reliable LoS path from among several beams within a single RU, spatially filtering NLoS components with larger delays to improve accuracy.
   2. DoA Fusion within Single RU:
      The system combines DoA estimation with the ToA of the most reliable beam for localization.
2. For Several RUs with One or More Beams
   1. High-Resolution ToA Estimates Across RUs:
      Collect high-resolution ToA estimates from multiple RUs with one or more beams.
   2. Selecting the Shortest Reliable Path Per RU:
      For each RU (which may provide multiple candidate beams), the system selects the shortest reliable ToA path and forwards it to a central unit for joint location computation.
3. Location Calculation Using TDoA and DoA:
   The system supports both standard TDoA and hybrid TDoA+DoA formulations for position estimation.
      5.2. Traditional TDoA Vs. Proposed Method

In classical TDoA systems, all RU delays are referenced to a chosen RU. This requires subtracting noisy measurements and assuming that the reference RU remains stable and in LoS. Such a rigid structure results in:
Amplification and correlation of noise due to delay subtraction.
Failure when the reference RU is under NLoS or weak SNR conditions.
Increased complexity in validating candidate positions across all possible reference permutations.

To address these limitations, we propose a reference-free formulation that directly models the ToA at each RU as

$${h}_{n} ( p , {t}_{0} ) = {t}_{0} + \frac{‖ p - {p}_{n} ‖}{c} + {z}_{n} , n = 0 , … , {N}_{RU} - 1$$

t₀ is a common emission time, estimated jointly.
p∈ [symbol] ^{d} is the unknown UE position.
pₙ∈ [symbol] ^{d} is the known position of the n-th RU.
zₙ is the measurement noise, with variance that may differ significantly between RUs

This approach models each RU's ToA independently, allowing dynamic weighting, rejection of unreliable RUS, and eliminating errors caused by referencing a single RU. The emission time to is jointly estimated within the Gauss-Newton solution and incorporated into the Kalman filter state vector using a modified Jacobian. t₀ is treated as a network-dependent variable that may drift or exhibit discontinuities between measurements, rather than a physical propagation delay.

5.3. Robust Estimation with Reliability-Aware Filtering

We introduce several enhancements to improve robustness of the positioning algorithm against noise, NLoS conditions, and RU asynchrony:
1. Reliability-Weighted Estimation:
   Each RU's measurement is assigned a dynamic weight or variance based on:
      SNR
      BW used for ToA estimation
      Delay spread or multipath dispersion from the time-domain spectrum
      Phase residual error in ToA Method 1
      Confidence scores from ToA Methods 4 and 5
   These weights are incorporated into Weighted GN or EKF updates, improving convergence while suppressing unreliable RUs. The GN algorithm starts from an initial position (prior knowledge or random) and iteratively updates the solution using the Jacobian at the current estimate, minimizing the weighted sum of squares

$$S ( p , {t}_{0} ) = {\sum }_{n = 0}^{{N}_{RU} - 1} {{w}_{n} ( {\hat{τ}}_{L o S , n} - {h}_{n} ( p , {t}_{0} ) )}^{2}$$

\hat{τ}_{LoS,n} is the estimated ToA from RU n
p, t₀ are updated iteratively until convergence
wₙ are reliability-based weights, updated between iterations to suppress outlier
2. Adaptive Outlier Rejection:
   Random Sample Consensus (RANSAC) based residual filtering rejects RUs with inconsistent delays.
   ANN classifiers trained to detect outlier delays under NLoS multipath.
3. Residual Clock Offset Estimation (Optional):
   For networks with shared clocks across RU subsets, residual clock offsets δₙ are added into the measurement model hₙ(p, t₀, δₙ). These parameters are estimated adaptively via GN or EKF when redundant reliable LoS RUs exist. The number of clock group offsets that can be estimated adaptively is N_{clocks}≤N_{RU}−d−1. This enables joint estimation of UE position and RU clock offsets in LoS-dominated conditions, when residual clock offsets are the primary error source.

### 5.4. Multi-Candidate ToA Measurements

Support for multi-candidate ToA measurements per RU is provided to improve robustness in position estimation and to enable advanced tracking algorithms such as multi-hypothesis tracking (MHT). Instead of selecting a single ToA estimate, multiple plausible delay candidates are retained and processed jointly. This approach allows:
Deferred decision-making: consistency across time and across RUs is enforced by evaluating multiple candidates before final selection.
Weighted fusion in positioning search: candidate delays are assigned reliability weights and incorporated probabilistically into GN or EKF/UKF updates.
Enhanced outlier and NLoS rejection: high-scoring but conflicting candidates may persist across several frames, enabling RANSAC- or ANN-based rejection schemes to filter unreliable paths before convergence.

By maintaining multiple ToA hypotheses per RU, the system achieves more robust initialization, improved resilience under multipath and NLoS conditions, and tighter integration with redundancy-based RU weighting and adaptive filtering.

### 5.5. Positioning Field Tests

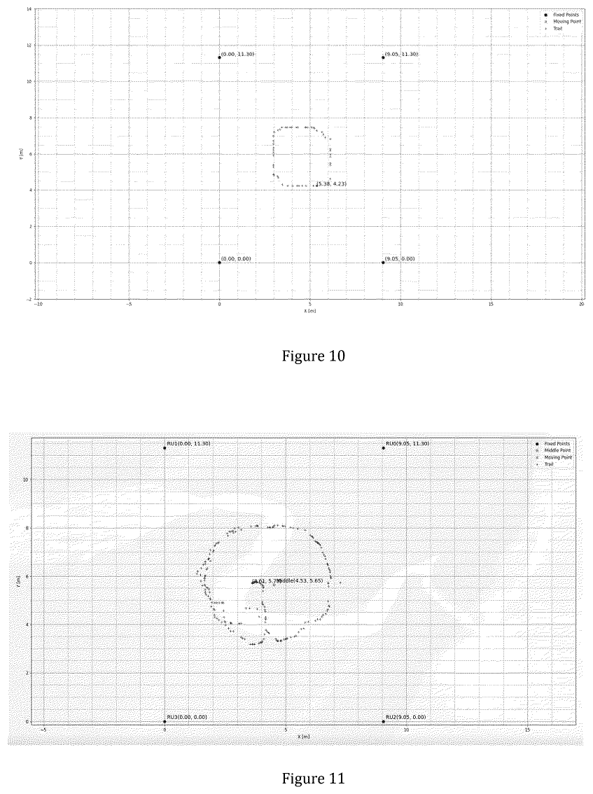

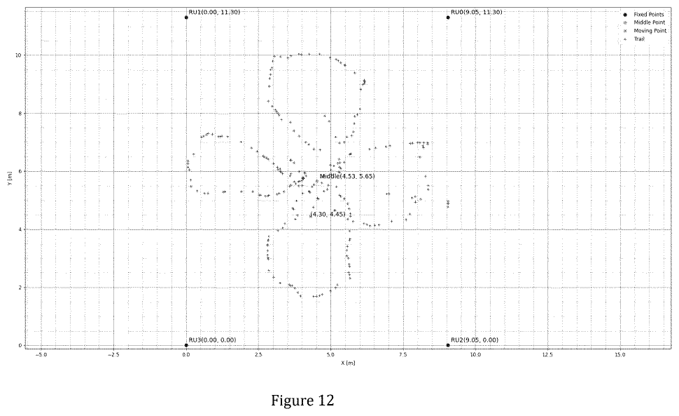

FIG. 10, FIG. 11, and FIG. 12 show two-dimensional (2D) positioning field tests conducted for a close-range UE using four distributed RUs in an outdoor parking area, demonstrating high-accuracy tracking of trajectories with square-, circular-, and flower-shaped walking paths. The ToA for each RU is estimated using joint FIAA and ESPRIT, and positioning is performed using robust outlier rejection of unreliable RU measurements.

### 6. Adaptive Localization Scheduler

In various embodiments, an adaptive localization scheduler is disclosed. The scheduler is configured (which may be ANN-trained in advance) to allocate radio resources for positioning purposes under varying environmental and service conditions while supporting coexistence with data communication resource allocations. The scheduler dynamically adapts its operation based on one or more quality-of-service (QoS) requirements, including but not limited to (i) a required level of positioning accuracy, (ii) a maximum latency budget, (iii) the mobility speed of the target device, and (iv) characteristics of the propagation environment such as indoor or outdoor deployment and multipath delay spread.

In some embodiments, the scheduler selects the resource allocation across time, frequency, bandwidth, beam management, and positioning pilot distribution. The adaptive behavior enables efficient utilization of radio resources while ensuring positioning performance is optimized for the target use case.

### 6.1. Allocation Logic

In an illustrative embodiment, the scheduler operates according to the following principles:
NLOS with high accuracy requirement: The scheduler allocates a relatively wide frequency bandwidth to improve delay resolution and support multipath separation.
High user mobility: The scheduler increases the temporal density of positioning pilots, thereby enabling accurate channel tracking under fast fading conditions.
LoS with stable propagation: The scheduler reduces pilot density, thereby conserving bandwidth and releasing resources for data transmission.
Short delay spread environment: The scheduler selects a wider subcarrier spacing for positioning pilots, which reduces the overall number of required pilot tones.
Low SNR: The scheduler applies pilot boosting, or alternatively, a dedicated uplink power control mechanism specifically for positioning pilots, to increase robustness of the measurements.
   6.2. Joint Scheduling with Data Communication

In certain embodiments, the scheduler functions as a mixed scheduler. In such a configuration, the scheduler performs a joint optimization of positioning resources and communication resources. For example, when positioning requirements are stringent (e.g., high accuracy with strict latency), the scheduler may increase pilot allocations while temporarily reducing data throughput. Conversely, when positioning requirements are relaxed (e.g., stable LoS conditions), the scheduler may allocate fewer pilots and release resources for data communication.

Through this adaptive mechanism, the scheduler ensures that positioning quality of service is maintained under diverse deployment scenarios while minimizing the overall impact on communication system capacity.

1. A method for estimating a Line-of-Sight (LoS) Time of Arrival (ToA) in an OFDM/OFDMA communication system, the method comprising obtaining a channel estimate using pilots or remodulated data; applying preprocessing decimation to the channel estimate; and estimating the LoS ToA using one or more of frequency-domain channel phase-based estimation, inverse fast Fourier transform (IFFT) peak search, rising-edge based estimation, a hybrid combination of Estimation of Signal Parameters via Rotational Invariance Techniques (ESPRIT) with Fast Iterative Adaptive Approach (FIAA), or an artificial neural network (ANN) model with a multi-layer perceptron (MLP) combiner for fusion with ESPRIT outputs; wherein the method provides centimeter-level precision under multipath and Non-Line-of-Sight (NLoS) conditions while adapting dynamically to bandwidth, signal-to-noise ratio (SNR), and delay spread.

2. The method of claim 1, wherein preprocessing decimation comprises first obtaining a coarse estimate of the LoS delay and shifting the time-domain channel impulse response (CIR) to zero delay by applying a rotation of the frequency-domain channel through multiplication by a complex exponential or equivalent downmixing operation, and subsequently applying overlapping windowed integration, and wherein the final LoS ToA is obtained as the sum of the coarse LoS estimate and a residual refinement estimated from the decimated vector by the methods of claim 1.

3. The method of claim 2, wherein the overlapping windowed integration uses a window function with high sidelobe attenuation on overlapping blocks to improve effective signal-to-noise ratio (SNR), suppress distant multipath, and robustly prevent aliasing of far multipath into the LoS region without delay-spread-dependent tuning of the decimation factor, wherein the decimation produces a compact fixed-length vector suitable for real-time processing.

4. The method of claim 1, wherein the frequency-domain channel phase-based estimation is applicable across all bandwidths and is particularly effective in narrowband LoS channels with few subcarriers. The estimation is performed by averaging phase differences across subcarrier pairs, the phase differences being obtained by complex conjugate multiplication of adjacent or non-adjacent subcarrier pairs, wherein multiple lag values between subcarriers are optionally combined with adaptive selection according to channel conditions, and wherein unreliable subcarrier bands are optionally discarded with the subcarrier selection dynamically updated based on current SNR or variance conditions.

5. The method of claim 1, wherein a window is applied to the frequency-domain channel estimate and the IFFT is performed with zero-padding to obtain an oversampled CIR, wherein the squared magnitude of the CIR is used to detect the earliest significant peak, and wherein a peak interpolation method is applied around the peak to refine the ToA estimate, the resulting ToA estimate being optionally used as an initialization for subsequent enhanced ToA estimation algorithms.

6. The method of claim 1, wherein rising-edge based estimation is performed by detecting and analyzing the rising edge of the earliest arriving path, the rising edge being less distorted by closely delayed NLoS multipath, the detection being performed using a threshold that is adaptable and trained according to SNR and spectrum features, and wherein a reference spectrum is generated under identical preprocessing conditions as the received signal spectrum, optionally including a bandwidth-dependent IFFT window that is optimized or trained on channel datasets to reduce sidelobe leakage and improve delay discrimination, optionally applying spectrum smoothing, estimating and removing a baseline noise level from the received signal spectrum, aligning the received signal with a reference signal using a gain-invariant alignment method, and estimating the LoS delay from the peak of the aligned reference relative to the received signal.

7. The method of claim 6, wherein the gain-invariant alignment method is performed using an approach such as searching over possible shifts and selecting the shift that maximizes a normalized correlation coefficient between a rising-edge portion of the reference and the detected rising edge of the received signal, wherein the alignment index is optionally refined by sub-bin interpolation of the correlation coefficient function.

8. The method of claim 1, wherein joint FIAA and ESPRIT LOS delay selection is performed by validating ESPRIT candidate delays against FIAA spectrum features, the validation including model-order filtering by rejecting ESPRIT roots not supported by the FIAA spectrum, and wherein the LoS delay is selected as the ESPRIT candidate with the highest confidence score when validation succeeds, and otherwise is selected directly from the FIAA spectrum.

9. The method of claim 8, wherein ESPRIT is implemented efficiently by constructing compact covariance matrices from decimated vectors through spatial smoothing with reused sub-vector outer products, and wherein FIAA is implemented efficiently using FFT-based Gohberg-Semencul, the denominator polynomial coefficients being computed directly via FFT convolution as an optimization that eliminates the need for triangular matrix multiplications and explicit diagonal summations, thereby enabling real-time execution on short, decimated vectors.

10. The method of claim 1, wherein an ANN is configured to process decimated vectors to suppress NLoS multipath components and enhance LoS features, and to output a complex-valued vector having the same dimension as the input to enable LoS delay isolation, and to directly estimate a scalar LoS-ToA using a post-processing ToA head.

11. The method of claim 10, wherein the ANN operates on separate real and imaginary channels and transforms the input by either a fully connected layer or a learnable real window followed by an IFFT layer to enhance time-domain features, the transformed input being processed by convolutional layers or transformer self-attention layers and subsequently by fully connected layers reconstructing a complex-valued output vector of equal dimension to the input.

12. The method of claim 10, wherein the direct scalar LoS-ToA estimation using a post-processing ToA head is implemented either as a deterministic calculation, including autocorrelation with phase-based delay extraction or an IFFT with maximum peak detection, or as a trainable head, including classification across delay bins or regression with confidence scoring.

13. The method of claim 1, wherein a multi-layer perceptron (MLP) fuses a pretrained ANN-derived delay estimate with ESPRIT-derived candidate delays based on inputs including covariance eigenvalue features and prior delay knowledge, dynamically weighting the ESPRIT delay closest to the ANN prediction to minimize hybrid estimation error, the hybrid fusion overcoming the accuracy floor of standalone ANN models in ideal channel conditions.

14. A method for positioning a user equipment (UE) in a communication system, the method comprising obtaining ToA measurements from multiple distributed radio units (RUs), the RUs being clock-synchronized in advance through calibration, for example using LoS transmitters with known locations, applying a reference-free Time-Difference-of-Arrival (TDoA) formulation in which each RU contributes an independent ToA equation without reliance on a fixed reference RU, wherein redundant RUs are used to support robust outlier rejection and adaptively selecting and weighting reliable LoS paths while rejecting outlier measurements from RUs in NLoS conditions so that positioning is maintained even when only a subset of RUs provide clear LoS paths, thereby achieving robust positioning under multipath, NLoS, and asynchronous RU conditions.

15. The method of claim 14, wherein the reference-free TDoA formulation models each RU measurement as a common emission time plus a propagation term and noise, the UE position being estimated jointly with the common emission time, the emission time being modeled as a network-dependent variable subject to synchronization drift, and wherein residual clock offsets across RU subsets are optionally estimated adaptively when redundant reliable LoS RUs are available, thereby avoiding noise amplification and error propagation associated with subtracting a fixed reference ToA.

16. The method of claim 14, wherein the UE position is initialized using Gauss-Newton optimization from one or more starting points with adaptively weighted RU measurements, outlier rejection being performed using techniques such as Random Sample Consensus (RANSAC) or ANN-based NLoS classifiers, and tracking being performed using filters such as extended or unscented Kalman filtering that update measurement variances based on RU reliability metrics while dynamically rejecting measurements inconsistent with the predicted position.

17. The method of claim 16, wherein RU weights are assigned based on reliability metrics including SNR, bandwidth, delay spread, and confidence scores, and wherein the common emission time and, when available, residual clock offsets across RU subsets are jointly estimated within the Gauss-Newton or Kalman filter solution by augmenting the filter state vector and applying a Jacobian modified to account for the additional parameters.

18. The method of claim 14, wherein multiple candidate ToA measurements per RU is supported so that the final position is determined by selecting the most consistent ToA candidates across RUs using a method such as multi-hypothesis tracking.

19. The method of claim 14, wherein positioning is improved by combining ToA measurements with Direction-of-Arrival (DoA) estimates from RUs equipped with receiver arrays, wherein multiple spatial beams are used either to spatially filter NLoS paths for TDoA positioning on the shortest reliable LoS path or to fuse the DoA with the ToA for hybrid TDoA and DoA positioning.

20. An adaptive localization scheduler for a wireless communication system, configured to allocate radio resources for positioning based on quality of service (QoS) requirements including at least one of accuracy, latency, mobility, or propagation environment, wherein the scheduler dynamically adjusts allocations in time, frequency, bandwidth, beam management, and pilot distribution, and further operates to jointly optimize positioning resources and communication resources.
